(19) United States
(12) Patent Application Publication
(10) Pub. No.: US 2006/0236364 A1
(43) Pub. Date: Oct. 19, 2006

(54) Policy based method, device, system and computer program for controlling external connection activity

(75) Inventors: Mikko Suni, Kirkonummi (FI); Pekka Sahi, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/097,952

(22) Filed: Mar. 31, 2005

(51) Int. Cl. H04L 9/00

(52) U.S. Cl. 726/1

(57) ABSTRACT

The invention relates to controlling of an activity of external connections and in particular in situation where a device lock is on. This is achieved by a method, a device, a system, a computer program product and a computer program. In the method it is detected that the device lock is on whereby it is determined whether there are at least one function requiring external connection. If such function is found, a device lock policy is checked for said at least one external connection and the external connection activity is controlled according to said device lock policy.

### FIELD OF THE INVENTION

This invention relates to controlling of an activity of external connections and in particular in situation where a device lock is on.

### BACKGROUND OF THE INVENTION

Mobile phones and other wireless terminals are known to have a feature called keypad lock (a.k.a. Keyguard or UI (User Interface) lock), which prevents the use of terminal's keypad. For locking and unlocking the keypad, the user needs to press a certain combination of keypad buttons (e.g. ‘Open’ and ‘*’). The purpose for the use of the keypad lock is to prevent the keys on the terminal from being accidentally pressed.

Currently some smart phones, e.g. some Nokia Communicator models, contain a functionality called device lock. Compared to the keypad lock, the device lock feature is more effective. Whereas the keypad lock locks the user interface (e.g. keypad), device lock is arranged to lock the whole system. When the device lock is on, any actions that require a network connection or external connection cannot be made, however the existing connections are maintained. Device lock can be turned on automatically after a certain time setting or a certain operation (e.g. change of a SIM card). When the device lock is turned on manually or by timer, access to the personal information, such as messages or document, is prevented even when the device itself is on. Nowadays the device lock can also be turned on remotely by means of a SMS message. This enables preventing use and access to the device, e.g. when the device has been stolen. The device lock can be turned on also remotely by any device capable of SMS messaging. To unlock the device lock, the user needs to enter a correct lock code (i.e. security code).

When the device lock is on, current systems prevent the creation of new external connections from other personal area networking devices to the device in question or vice versa. Such external connections can be made utilizing different communication technology protocols and technologies e.g. WLAN, IrDA, Bluetooth or USB (Universal Serial Bus). These external connections can be used for transferring information between devices having the connection in question arranged therein between. Both Infrared and Bluetooth are wireless connecting methods. For making a link between devices by Infrared the devices need to be pointed to each other. However, Bluetooth operates in short range radio system and no visual connection is necessarily needed.

USB is a high-speed serial bus technology that is used to link a USB host (e.g. a personal computer (PC)) and USB peripheral devices (later “device”). The connection is currently made by wired link, but also wireless link will be true in the future (Wireless USB, WUSB). The device can be, for example, a keyboard or a printer, but also a wireless terminal (e.g. mobile phone). Currently most wireless devices act as a USB device and the PC acts as a host, whereby the wireless terminal can be used for connecting the PC into the wireless data network, or the PC can be used for connecting the wireless terminal into wired data network. Also via USB link the wireless terminal and the PC can be synchronized together for sharing data and files between each other.

As mentioned, the use of a device lock currently prevents new external personal area connections whereby the device security in that case is assured. However sometimes new connections may be needed, even when the device lock is on. Even though new external connections are prevented, existing connections are yet maintained, whereby the device security may be prejudiced in that case. Hence there is currently a conflict between device lock turning on and in a use of the external connection. This invention aims to dissolve the conflict.

### SUMMARY OF THE INVENTION

A solution is needed for maintaining the security via the device lock, when external connections are active, but also when new external connections are made. The current invention is addressed to such a need. This invention provides a method, a device, a system and a computer program for controlling an activity of at least one external connection.

In the method an activation of a device lock is detected, whereby at least one function being arranged to use at least one external connection is determined, whereby a device lock policy for said at least one external connection is checked, and the external connection activity is controlled according to said device lock policy.

The device is capable of forming an external connection to another device and of controlling an activity of said external connection, said device further comprising a device lock, whereby the device is further capable of detecting that said device lock is on, determining if at least one function is arranged to use at least one external connection, whereby the device is further capable of checking a device lock policy for said at least one external connection and controlling the external connection activity according to said device lock policy.

The system comprises at least a first device and a second device having an external connection therein between, said first device comprising a device lock, whereby the system is capable of detecting that said device lock is on, determining of at least one function is arranged to use at least one external connection, whereby the system is capable of checking a device lock policy for said at least one external connection and controlling the external connection activity according to said device lock policy.

The computer program product being stored on a medium comprises computer readable instructions for controlling an external connection activity in a device by detecting that a device lock is on, determining if at least one function is arranged to use at least one external connection, whereby a device lock policy for said at least one external connection is checked, and the external connection activity is controlled according to said device lock policy.

In the current invention ‘activity of an external connection’ refers to data transfer (i.e. communication) between at least two devices using the external connection. ‘Controlling the external connection activity’ refers to functionality of choosing to allow or not to allow the external connection activity.

Further, the ‘policy’ comprises rules for determining how the external connection is controlled for different types of functions and different methods for turning on the device lock. In this solution, the existing external connections and their security are determined. Therefore, if the device lock is turned on, some of the connections are allowed and some are prevented.

The advantages of this solution compared to the related art relates to usability and security. The solution enables the usage of selected device connections even when device lock is on. The device connections are enabled if they fulfill policies. These policies may be predetermined or they may be dynamically changing. Dynamically changing policies are needed when existing policies are not suitable for a new situation. This situation may occur when e.g. new functionality requiring external connection is added into the device. Also detecting a security risk may require modifications to policies. This solution improves usability of the device and increases the user experience, because connections can be maintained and started even though the device lock is turned on. However, even if this is possible, the unwanted connections can be prevented.

### DESCRIPTION OF THE DRAWINGS

The accompanying drawings, which are incorporated in and constitute a part of this specification, illustrate examples relating to this solution and, together with the description, explain further objects and advantages of the solution. In the drawings

FIG. 1 illustrates an example of the USB subsystem architecture of a wireless device,

FIGS. 2a, and 2b illustrate simplified examples of message flows in a USB subsystem, and

FIG. 3 illustrates an example of a wireless device as a block diagram.

### DETAILED DESCRIPTION OF THE INVENTION

Although specific terms are used in the following description for the sake of clarity, these terms are intended to refer only to the particular structure of one example (USB) selected for illustration in the drawings. In the description term “wireless terminal” refers to an electronic device being capable of an external connection (e.g. personal area connection) that forms a link between at least two devices, such as the wireless terminal and an external device. Even though in this description the example relates to USB connections, it should be kept in mind that also other external connections can utilize the invention. As examples of other communication protocols for external connections Bluetooth, IrDA, WLAN, Firewire, Wireless Firewire and WUSB are mentioned. Therefore it will be appreciated by the man skilled in the art that other external connection can be used as well, which provide communication link between devices. The wireless terminal has also functionality for device locking (DL). The device lock is launched by a method and means for turning on the device lock, which method can be a timer expiry, messaging (e.g. SMS), manual inputting or the like. Other methods are appreciated by the man skilled in the art, which methods set the device lock on. Term “function” relates to an activity that may utilize the external connection. Function can be file transferring, downloading, printing etc. For carrying out such a function, the connection needs to be formed or it can already be on. Type of a function identifies more specifically the function by e.g. function identifiers or function class identifiers. “USB session” refers to a situation, where USB cable is connected and enumeration is done. Enumeration is a process, where detected USB device describes itself by supplying enumeration data to the host at the host's requests.

As mentioned earlier, most current wireless devices act in a USB device role. However, the situation where a wireless terminal can act as a USB host will raise new use possibilities. For example, files can be transferred between wireless terminals, documents can be printed directly from the wireless terminal to a printer, a USB keyboard can be utilized by the wireless terminal in addition to a headset or other USB devices. Any configuration of USB implementations on a device has to be matched by a corresponding set of host side drivers. For an example wherein the headset is a device, the headset is categorized into an HID (Human-Interface Device) class. Therefore the host (in this example the wireless terminal) needs to load the HID host class driver in order to communicate with the device (i.e. the headset).

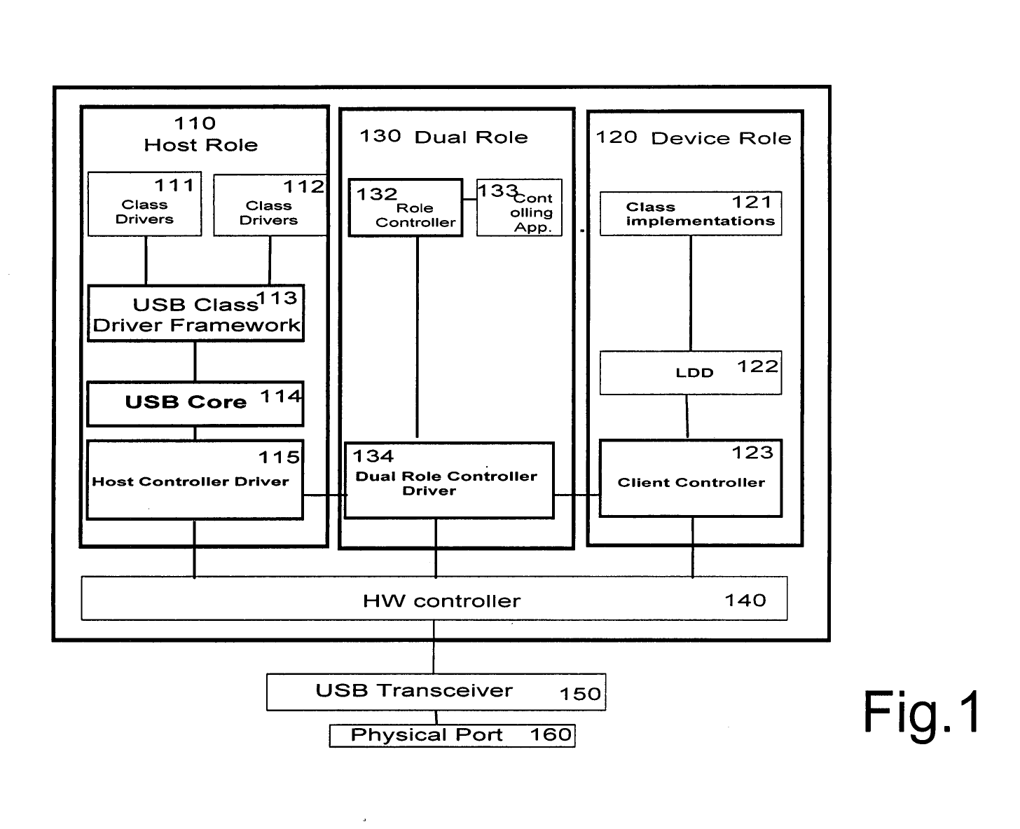

The following description is divided into two categories depending on whether the wireless terminal acts as a host or whether the wireless terminal acts as a device for the USB connection. FIG. 1 illustrates the USB subsystem architecture of the wireless terminal in both of the situations and is discussed in more detailed manner afterwards. The description will highlight case examples from certain USB class functionalities, but the principles of the discussion can be generalized so as to be applicable to other functionalities as well. The case examples highlight the need for different policies for different USB class functionalities, and thus also the need for the invention.

A) Examples of the Method When the Terminal Acts as a Host

In the first example the wireless terminal has USB printer class host functionality. The terminal is capable of connecting to a printer with a USB printer class implementation. The following table 1 illustrates a simplified example of the security policy with a printer device.

TABLE 1
Policy to govern USB host connectivity with USB Printer class
device

| | | Event: DL | Event: DL | |
|---|---|---|---|---|
| | Event: USB | on | on | Event: DL on |
| Precondition | cable in | (Timer) | (Manual) | (message) |
| USB off, | Open UI lock, | N/A | N/A | N/A |
| DL on | prompt security | | | |
| | code in | | | |
| | terminal. | | | |
| | Keep USB | | | |
| | disabled | | | |
| USB on, | N/A | Keep USB | Keep USB | Disable USB |
| DL off | | enabled | Enabled | |

Table 1 represents situations depending on the states of USB and device lock (DL). In a first precondition the USB connection is off and the device lock is on. When the USB connection is aimed to be formed between a host (wireless terminal) and a device (printer class device), the USB connection is not established in order to ensure security. Instead, the host prompts for the security code needed to open the device lock. Opening the device lock may also cause an automatic establishment of the USB connection. On the other hand, in a second precondition the USB connection is on at first (already established) and the device lock is off. When the device lock is turned on the method that turned on the device lock is checked. This means that it is determined how the device lock is turned on, and that information is used for handling the USB connection. For example, when the device lock is turned on through timer expiry or user action, the USB connection is kept enabled. This ensures that an ongoing printing function will go on despite the device lock event in order not to harm the user experience. But when the same precondition applies, and the device lock is turned on through a valid messaging received by the host, USB connection is ceased. This is because the host (i.e. wireless terminal) might have been stolen, and the user or the operator disables all use of it through the messaging that sets the device lock on.

In the second example, the method can be utilized when files are transferred between wireless terminals using mass storage class. For doing that, wireless terminals need to have USB host functionality (e.g. OTG) and mass storage class (MSC) support. USB OTG (On-The-Go) is an extension of the USB for connecting wireless terminals to each other. USB OTG terminals can communicate with each other without the need to be connected to a PC. If the user of the first terminal wants to get a file from the user of the other terminal, the wireless terminals are connected and the transfer may begin. The policy for controlling the file transfer depends on the phase where the device lock is turned on. If the device lock is turned on before the file transfer is begun, the file transfer is not allowed until a correct security code is entered. If the file transfer is in motion, when the device lock is turned on, the transfer is allowed to go to the end, unless the methods for turning on define otherwise. However, no new file transfers can be made before the correct security code is entered. Table 2 represents situations depending on the states of USB and device lock (DL) for mass storage class.

TABLE 2
Policy to govern USB host connectivity
with USB Mass Storage Class device.

| | | Event: | | |
|---|---|---|---|---|
| | Event: USB | DL on | Event: DL | Event: DL on |
| Precondition | cable in | (Timer) | on (Manual) | (message) |
| USB off, | Open UI lock, | N/A | N/A | N/A |
| DL on | prompt | | | |
| | security code | | | |
| | in terminal. | | | |
| | Keep USB | | | |
| | disabled | | | |
| USB on, | N/A | Keep | Keep USB | Disable USB |
| DL off | | USB | Enabled | |
| | | enabled | | |

In the third example, the USB keyboard is used. In this example the wireless terminal has USB HID (Human Interface Devices) class driver and a keyboard with USB HID class implementation available. If the device lock is turned on by the timer before or during the user typing with the keyboard (USB enabled), the keyboard is still allowed to be used for turning off the device lock. This can be done by entering the correct security code with the USB enabled keyboard. Other operations with the keyboard are declined. In one example, the device lock can be turned off by plugging in the USB enabled keyboard after the device lock has been activated and then entering the unlock code using the USB enabled keyboard. Table 3 represents situations depending on the states of USB and device lock (DL) for HID.

TABLE 3
Policy to govern USB host connectivity with USB Human
Interface Devices.

| | | | Event: | |
|---|---|---|---|---|
| | Event: USB | Event: DL | DL on | Event: DL on |
| Precondition | cable in | on (Timer) | (Manual) | (message) |
| USB off, | Open UI lock, | N/A | N/A | N/A |
| DL on | prompt | | | |
| | security code | | | |
| | in terminal. | | | |
| | Enable code | | | |
| | input through | | | |
| | USB, disable | | | |
| | other traffic | | | |
| | through USB | | | |
| USB on, | N/A | Enable | Enable | Disable USB |
| DL off | | code input | code input | |
| | | through | through | |
| | | USB, | USB, | |
| | | disable | disable | |
| | | other | other traffic | |
| | | traffic | through | |
| | | through | USB | |
| | | USB | | |

In the fourth example, the user has a wireless terminal that has USB Display Headset functionality and USB enabled Display Headset available. In this situation, usability may be improved if the security code can (in “cable in” events) be given through the controls of the Display Headset device e.g. when the terminal is deep in the user's pocket. Table 4 represents situations depending on the states of USB and device lock (DL) for Display Headset.

TABLE 4
Policy to govern USB host connectivity with USB Display
Headset.

| | | Event: | Event: DL | |
|---|---|---|---|---|
| | Event: USB | DL on | on | Event: DL on |
| Precondition | cable in | (Timer) | (Manual) | (message) |
| USB off, | Keep UI lock | N/A | N/A | N/A |
| DL on | on, prompt | | | |
| | security code in | | | |
| | device. | | | |
| | Enable code | | | |
| | input through | | | |
| | USB, disable | | | |
| | other traffic | | | |
| | through USB. | | | |
| | After security | | | |
| | code accepted, | | | |
| | enable USB but | | | |
| | put DL back on. | | | |
| USB on, | N/A | Keep | Keep USB | Disable USB |
| DL off | | USB | Enabled | |
| | | enabled | | |

B) Examples of the Method When the Terminal Acts as a Device

In the first example (see table 5) the user has a wireless terminal and a personal computer, both of which have USB WMCDC ACM (Wireless Mobile Communication Device Class, Abstract Control Modem) capability. In this example the user wants to connect the personal computer to the network by using the wireless terminal as a connecting device. At the same time the user wants to protect the personal computer (and the wireless terminal) from possible attacks via USB connection. In this kind of a situation the user connects the terminal and the personal computer and calls to a known e.g. ISDN number using a PC connection application. The wireless terminal is connected to the network and begins routing data between the network and the personal computer. If, during the connection, the timer automatically or the user manually sets the device lock on, the data routing to outside the network continues until the USB cable is disconnected, after which the external connection are prevented and no new network connections can be made until a correct security code is entered.

TABLE 5
Policy to govern USB WMCDC ACM device connectivity.

| | | | Event: | |
|---|---|---|---|---|
| | Event: USB | Event: DL | DL on | Event: DL on |
| Precondition | cable in | on (Timer) | (Manual) | (message) |
| USB off, | Open UI | N/A | N/A | N/A |
| DL on | lock, prompt | | | |
| | security code | | | |
| | in terminal. | | | |
| | Keep USB | | | |
| | disabled | | | |
| USB on, | N/A | Keep USB | Keep | Disable USB |
| DL off | | enabled | USB | |
| | | | enabled | |

In the second example (table 6) the user wants to synchronize selected data (e.g. calendar and contact details) between wireless terminal and personal computer, both of which have USB OBEX CDC (Object Exchange Communication Device Class) capability. The wireless terminal contains a synchronization button and the personal computer has PC connectivity software installed. The synchronization is finished up despite the device lock as long as the device lock is turned on by timer or manually by the user.

TABLE 6
Policy to govern USB OBEX CDC device connectivity.

| | | | Event: | |
|---|---|---|---|---|
| | Event: USB | Event: DL | DL on | Event: DL on |
| Precondition | cable in | on (Timer) | (Manual) | (message) |
| USB off, | Open UI | N/A | N/A | N/A |
| DL on | lock, prompt | | | |
| | security code | | | |
| | in terminal. | | | |
| | Keep USB | | | |
| | disabled | | | |
| USB on, | N/A | Keep USB | Keep USB | Disable USB |
| DL off | | enabled | enabled | |

In the third example (table 7) the user wants to transfer files from the personal computer to a terminal mass memory card (MMC), which personal computer and wireless terminal have USB capability and both support USB mass storage protocol. At first the device lock is off. The user then connects the wireless terminal and the personal computer via USB cable. If during the procedure, the device lock is turned on, the policy is used for determining whether the current operation should be allowed. If the device lock is turned on by timer or manually before the file transfer is started, the transfer is allowed, and if the device lock is turned on by timer or manually during the file transfer, the transfer is continued to the end. After finishing the file transfer, no new file transfer can be started unless right security code is entered.

TABLE 7
Policy to govern USB Mass Storage device connectivity.

| | | | Event: | Event: DL |
|---|---|---|---|---|
| | Event: USB | Event: DL | DL on | on |
| Precondition | cable in | on (Timer) | (Manual) | (message) |
| USB off, | Open UI | N/A | N/A | N/A |
| DL on | lock, prompt | | | |
| | security code | | | |
| | in terminal. | | | |
| | Keep USB | | | |
| | disabled | | | |
| USB on, | N/A | Keep USB | Keep USB | Disable USB |
| DL off | | enabled | enabled | |

Implementation

The implementation of previous examples is carried out by slightly different device implementations depending on the role of the wireless device. A simplified example is illustrated in FIG. 1 which depicts the USB subsystem architecture as a block diagram. The wireless terminal acting as a USB host (block 110) uses a different set of software components as when the same terminal is acting as a USB device (block 120).

On the USB device side (120), the USB cable events are listened to or for (monitored) as well as the device lock events, whereby USB services (i.e. USB class implementations (121)) based on those events are started and stopped. Logical device driver (LDD 122) is a software component that enables the class implementations to access the more hardware-oriented layers below. The client controller 123 acts as an interface to hardware controller 140. It is possible to include an additional policy controller component that governs the starting and stopping of USB class implementations based on the security rules that are static or dynamic. The policy controller component can fetch information on what actions it should take in the USB cable events and device lock events at hand. The subsystem can comprise a component for launching and controlling USB related system message events on the user interface (e.g. security code queries). When the wireless terminal has a host role 110, the host controller driver 115 acts as an interface to hardware controller 140. USB core 114 is mainly in charge of tasks of host side 110. USB class driver framework 113 loads the class drivers 111, 112 as a response to a command from USB core 114. The class drivers 111, 112 implement the tasks for USB classes. As when the terminal acts as a device, it is possible in this case also to include an additional policy controller component that achieves the policy-based control for an external connection.

In a situation where the wireless terminal has a dual role, e.g. in OTG, the role controller 132 and controlling application 133 may launch the role change between host and device. Dual role controller driver 134 acts as an interface to hardware controller 140. The USB cable itself is connected via physical port 160 to USB transceiver 150.

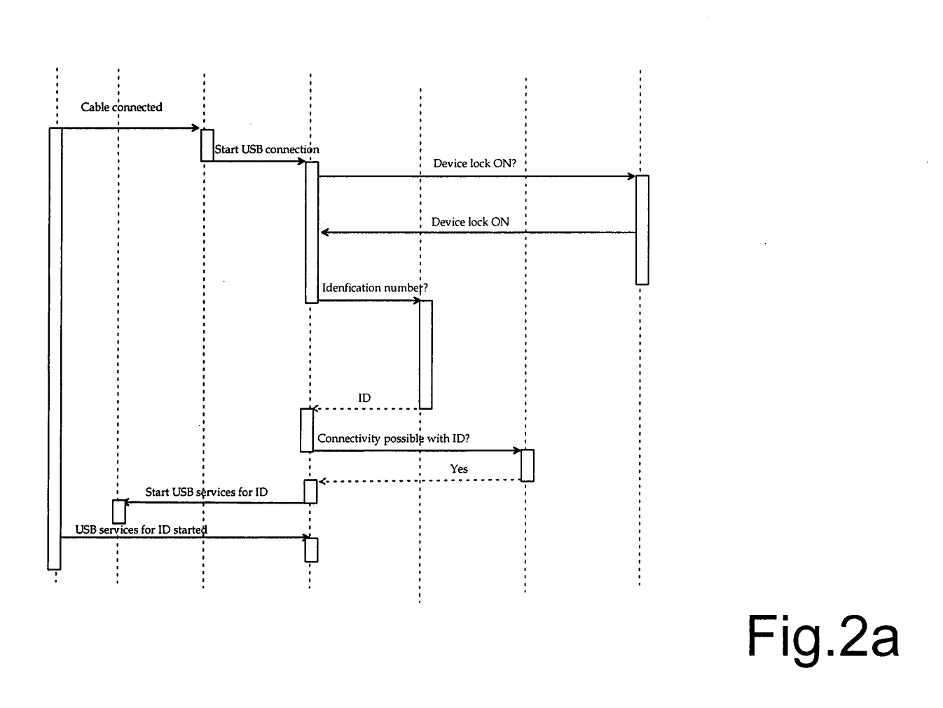

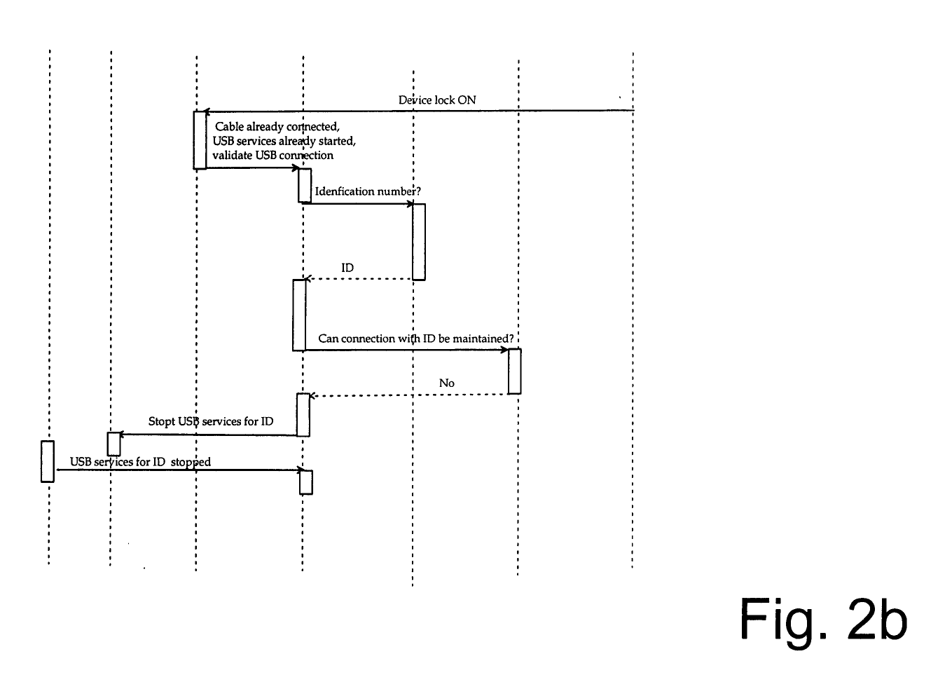

FIG. 2a illustrates one example of the possible message flow between the participating objects in the USB subsystem in a very simplified manner. When the cable is connected an order is received to start a USB connection. At first it is checked if the device lock is on, and informed that the device lock is on. Then an identification number is received, which identification number defines the USB class to be started. After that it is checked if the USB connectivity for the identification number is possible. After getting a positive answer, a command to start USB services specified with the identification number is issued in order to start the corresponding USB class implementation.

FIG. 2b illustrates basically a similar situation as that of FIG. 2a. The main difference compared to FIG. 2a is that the external connection is already established when the device lock becomes on, and that this time connectivity is rejected based on the security rule on the policy.

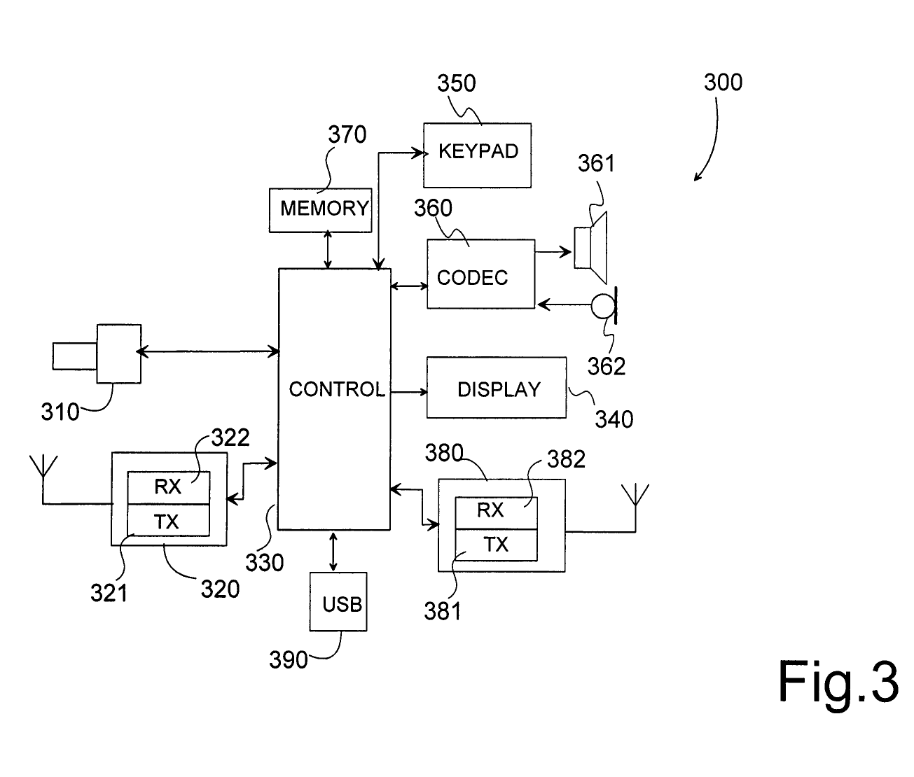

FIG. 3 illustrates one example of a wireless device. The device 300 comprises a communication means 320 having a transmitter 321 and a receiver 322 or the device is connected to such. There can also be other communicating means 380 having a transmitter 381 and a receiver 382 as well. The first communicating means 320 can be adapted for a long-range telecommunication system such as but not limited to a GSM, WCDMA, GPRS/EDGE, or cdma2000 system and the other communicating means 380 can be a kind of short-range communicating means, such as a Bluetooth™ system, a WLAN system (Wireless Local Area Network) or other system which suits local use and for communicating with another device. In addition, the device 300 comprises USB port 390 for connecting to an external device. The device 300 also comprises a display 340 for displaying visual information, e.g. web pages. In addition the device 300 may comprise an interaction means, such as a keypad 350 for inputting data etc. In addition or instead of the keypad 350, the device can further comprise a stylus, where the display is a touch-screen display. The device 300 can also comprise audio means 360, such as an earphone 361 and a microphone 362 and optionally a codec for coding (and decoding, if needed) the audio information. The device 300 also comprises a control unit 330 for controlling functions, tasks and running applications in the device 300. The control unit 330 may comprise one or more processors (CPU, DSP). The device further comprises memory 370 for storing e.g. data, applications, computer program code. The method itself can be implemented by a program code that can be stored on a memory of the device.

The previous description uses USB as an example for the method controlling external connection. As said, USB is only one possible communication protocol that can utilize the method. Every communication method (mentioned above) has its own specific features that do not necessarily have an impact on the current method. However, what should be remembered is that the method for controlling the connection is based on predetermined policies that are related to the device lock in the device. Therefore, substantially every external connection can be controlled by a similar policy checking. As one example, a system could be described comprising two devices, e.g. a MP3 player and a headset between which an external connection, such as a Bluetooth connection is formed. In this example also, the connection is maintained or interrupted according to device lock policy, which is checked from the device's memory. For example, when the device lock turned on due to direct user interaction, the external connection is allowed until the function using said external connection is finished. Similarly, when device lock is turned on remotely via alarm, from an operator, by using a network or the like, functions using said external connection may be interrupted. Similarly, the device lock policies can have also policies for downloading times, sizes, estimated downloading costs etc. The policies can be combined, whereby if e.g. music files are transferred from the internet by means of a personal computer and device lock is turned on, then is possible to determine how much time the file transfer is expected to spend in total and how much time it has already spent. By a difference between them, another policy for interrupting the transfer may be set. The device policy can also be reconfigured at least when functionalities are added into the device or some other updating or developing is occurring. By understanding the possibilities for the use of the policy method, then it is understood that any variations and modifications of the examples of the embodiments described are possible without departing from the spirit and scope of protection of the invention as set forth in the claims.

We claim:

1. A method for controlling an external connection activity in a device, comprising
detecting that a device lock is on,
determining if at least one function is arranged to use at least one external connection, whereby
a device lock policy for said at least one external connection is checked, and
the external connection activity is controlled according to said device lock policy.

2. The method according to claim 1, wherein all external connections of said function are controlled according to a same policy.

3. The method according to claim 1, wherein the device lock is turned on during the external connection activity.

4. The method according to claim 1, wherein the device lock is turned on after which the external connection is established.

5. The method according to claim 1, wherein at least a function type or a method for turning on the device lock are identified in the device lock policy, whereby a decision for allowing the external connection is based on said policy.

6. The method according to claim 1, wherein the device policy is reconfigured at least when functionality is added into the device.

7. The method according to claim 1, wherein communication protocol for said external connection is one of the following: WUSB, USB, IrDA Bluetooth, WLAN, Firewire, Wireless Firewire.

8. A device being capable at least of forming an external connection to another device and of controlling an activity of said external connection, said device further comprising a device lock, whereby the device is further capable of
detecting that said device lock is on,
determining if at least one function is arranged to use at least one external connection whereby the device is further capable of
checking a device lock policy for said at least one external connection and
controlling the external connection activity according to said device lock policy.

9. The device according to claim 8, being capable of controlling all external connections of the said function according to a same device lock policy.

10. The device according to claim 8, wherein at least a function type or a method for turning on the device lock are identified in the device lock policy, whereby the device is arranged to make a decision for allowing the external connection based on said policy.

11. The device according to claim 8, being capable of reconfiguring the device policy at least when functionality is added into said device.

12. The device according to claim 8, wherein communication protocol for said external connection is one of the following: WUSB, USB, IrDA Bluetooth, WLAN, Firewire, Wireless Firewire.

13. The device according to claim 8, further comprising mean for telecommunications.

14. The device according to claim 8 being adapted to open the device lock by means of said another device.

15. A system for controlling an external connection activity in a device, comprising at least a first device and a second device having an external connection therein between, said first device comprising a device lock, whereby the system is capable of
detecting that said device lock is on,
determining if at least one function is arranged to use at least one external connection, whereby the system is capable of
checking a device lock policy for said at least one external connection and
controlling the external connection activity according to said device lock policy.

16. The system according to claim 15, wherein communication protocol for said external connection is one of the following: WUSB, USB, IrDA Bluetooth, WLAN, Firewire, Wireless Firewire.

17. A computer program product being stored on a medium, comprising computer readable instructions for controlling an external connection activity in a device by
detecting that a device lock is on,
determining if at least one function is arranged to use at least one external connection, whereby
a device lock policy for said at least one external connection is checked, and
the external connection activity is controlled according to said device lock policy.

18. The computer program product according to claim 17, wherein all external connections of said function are controlled according to same policy.

19. The computer program product according to claim 17, wherein at least a function type or a method for turning on the device lock are identified in the device lock policy, whereby a decision for allowing the external connection is based on said policy.

20. The computer program product according to claim 17, wherein the device policy is reconfigured at least when functionality is added into the device.

21. The computer program product according to claim 17, further comprising mean for telecommunications.

22. The computer program product according to claim 17, wherein communication protocol for said external connection is one of the following: WUSB, USB, IrDA Bluetooth, WLAN, Firewire, Wireless Firewire.
